(19) United States
(12) Patent Application Publication
(10) Pub. No.: US 2026/0221094 A1
(43) Pub. Date: Jul. 30, 2026

(54) INTERNAL COMPENSATION PIXEL DRIVING CIRCUIT, DISPLAY PANEL AND DRIVING METHOD

(71) Applicant: Everdisplay Optronics (Shanghai) Co., Ltd., Shanghai (CN)

(72) Inventors: Yong LI, Shanghai (CN); Yeke LOU, Shanghai (CN); Haitao YAN, Shanghai (CN)

(73) Assignee: Everdisplay Optronics (Shanghai) Co., Ltd., Shanghai (CN)

(21) Appl. No.: 19/434,161

(22) Filed: Dec. 29, 2025

(30) Foreign Application Priority Data
Jan. 24, 2025 (CN) 2025101218346

(51) Int. Cl. G09G 3/3233

(52) U.S. Cl. CPC G09G 3/3233; G09G 2300/0819; G09G 2300/0842; G09G 2300/0861; G09G 2310/08; G09G 2320/0247; G09G 2320/045; G09G 2330/021

(57) ABSTRACT

The present disclosure provides an internal compensation pixel driving circuit, display panel and driving method, the circuit includes: a light-emitting control subcircuit, a compensation subcircuit for eliminating the influence of the threshold voltage of a driving subcircuit on the light-emitting current provided by a light-emitting component, the driving subcircuit providing a driving current for the light-emitting component, a reset subcircuit, a first and second writing subcircuits, and the light-emitting component; the compensation subcircuit, the light-emitting control subcircuit and a first terminal of the driving subcircuit are connected to a fourth node, the compensation subcircuit, the first writing subcircuit and a gate of the driving subcircuit are connected to a second node, the reset subcircuit, the light-emitting component and a second terminal of the driving subcircuit are connected to a third node, and the second writing subcircuit and the first writing subcircuit are connected to the first node.

### CROSS REFERENCE

This application is based upon and claims priority to Chinese Patent Application No. 2025101218346, filed on Jan. 24, 2025, the entire contents thereof are incorporated herein by reference.

### TECHNICAL FIELD

The present disclosure relates to the field of circuit of display panels, and specifically, to an internal compensation pixel driving circuit, display panel and driving method.

### BACKGROUND

In recent years, as consumers have higher and higher requirements for the battery life of portable electronic devices (such as smart phones, tablet computers, wearable devices, etc.), reducing the power consumption of display panels has become one of the key factors in extending the battery life of devices. Among the many technologies for reducing the power consumption of display panels, low refresh rate display technology has attracted much attention due to its significant energy-saving effect.

It should be noted that the information applied in the above background section is only used to enhance the understanding of the background of the present disclosure, and therefore may include information that does not constitute prior art known to those skilled in the art.

### SUMMARY

An aspect of the embodiments of the present disclosure provides an internal compensation pixel driving circuit, including: a light-emitting control subcircuit, a compensation subcircuit, a driving subcircuit, a reset subcircuit, a first writing subcircuit, a second writing subcircuit, and a light-emitting component;
where the compensation subcircuit, the light-emitting control subcircuit and a first terminal of the driving subcircuit are connected to a fourth node, the compensation subcircuit, the first writing subcircuit and a gate of the driving subcircuit are connected to a second node, the reset subcircuit, the light-emitting component and a second terminal of the driving subcircuit are connected to a third node, and the second writing subcircuit and the first writing subcircuit are connected to a first node; and
the driving subcircuit provides a driving current for the light-emitting component, and the compensation subcircuit is used to eliminate an influence of a threshold voltage of the driving subcircuit on a light-emitting current provided by the light-emitting component.

Another aspect of the embodiments of the present disclosure further provides a display panel, including the above-mentioned internal compensation pixel driving circuit.

Another aspect of the embodiments of the present disclosure further provides a driving method of the above-mentioned internal compensation pixel driving circuit, including following stages:
in a first stage, inputting a high-level signal to the first control terminal and the second control terminal, inputting a low-level signal to the third control terminal and the fourth control terminal, the compensation subcircuit and the first writing subcircuit being in a conducting state, and transmitting a data signal of the data terminal to the first node;
in a second stage, inputting a high-level signal to the first control terminal and the third control terminal, inputting a low-level signal to the second control terminal and the fourth control terminal, the second writing subcircuit and the reset subcircuit being in a conducting state, and writing a data signal to the second node; and
in a third stage, inputting a high-level signal to the third control terminal and the fourth control terminal, inputting a low-level signal to the first control terminal and the second control terminal, the second writing subcircuit and the light-emitting control circuit being in a conducting state, controlling a working state of the driving subcircuit by a data signal, and driving the light-emitting component to emit light.

In some optional embodiments, the internal compensation pixel driving circuit also includes a reset circuit, and the reset circuit is connected to the fourth node;
in the first stage, a high potential of a previous frame stored in the reset circuit is written into the second node to turn on the driving subcircuit.

It should be understood that the above general description and the detailed description below are only exemplary and explanatory, and cannot limit the present disclosure.

### BRIEF DESCRIPTION OF THE DRAWINGS

The drawings herein are incorporated into the specification and constitute a part of the specification, showing the embodiments consistent with the present disclosure, and are used together with the specification to explain the principles of the present disclosure. Obviously, the drawings described below are only some embodiments of the present disclosure. For those skilled in the art, other drawings can also be obtained based on these drawings without creative work.

FIG. 1 is a schematic diagram of an overall circuit structure of an internal compensation pixel driving circuit according to an embodiment of the present disclosure;

FIG. 2 is a schematic diagram of a circuit connection of the internal compensation pixel driving circuit according to an embodiment of the present disclosure;

FIG. 3 is a waveform diagram of an internal compensation pixel driving circuit during working according to an embodiment of the present disclosure.

M1—first transistor, M2—second transistor, M3—third transistor, M4—fourth transistor, M5—fifth transistor, M6—sixth transistor, N1—first node, N2—second node, N3—third node, N4—fourth node, Cst—first storage unit, C1—second storage unit, S1—first control terminal, S2—second control terminal, EM1—third control terminal, EM2—fourth control terminal, DATA—data terminal, VDD—first power supply voltage line, VSS—second power supply voltage line, VINT—reference voltage terminal.

### DETAILED DESCRIPTION

In order to make the technical problems solved, the technical solutions adopted and the technical effects achieved by the present disclosure clearer, the technical solutions of the embodiments of the present disclosure will be further described in detail below in conjunction with the accompanying drawings. Obviously, the described embodiments are only part of the embodiments of the present disclosure, not all of them. Based on the embodiments of the present disclosure, all other embodiments obtained by those skilled in the art without creative work are within the scope of protection of the present disclosure.

In addition, the described features, structures or characteristics can be combined in one or more embodiments in any suitable manner. In the following description, many specific details are provided to give a full understanding of the embodiments of the present application. However, those skilled in the art will appreciate that the technical solutions of the present application can be practiced without one or more of the specific details, or other methods, modules, apparatuses, steps, etc. can be adopted. In other cases, the well-known modules, methods, apparatuses, implementations, steps, or operations are not shown or described in detail to avoid blurring the various aspects of the present application.

Traditional thin film transistor (TFT) backplane technology, such as low temperature polycrystalline silicon (LTPS) TFT, has a high electron mobility and is suitable for high refresh rate display applications. However, at low refresh rates, due to the large leakage current of TFT, it is easy to cause the display screen to flicker, affecting the display quality. In order to solve this problem, the current mainstream low refresh rate display technology usually adopts a hybrid pixel circuit structure, that is, a hybrid pixel circuit is formed by combining LTPS TFT and oxide TFT (such as IGZO). The oxide TFT has a low leakage current characteristic, which can effectively avoid screen flickering at low refresh rates. However, this hybrid pixel circuit structure also has some obvious disadvantages. First, the process is complicated. The hybrid pixel circuit needs to combine two different TFT technologies, which makes the process more complicated, and increases the difficulty of production and the process time. Secondly, the cost increases. Since more masks and process steps are required, the manufacturing cost of the hybrid pixel circuit also increases accordingly. In addition, the integration is limited. The complex structure of the hybrid pixel circuit also limits the integration of pixels, which is not conducive to achieving high-resolution display. However, the pixel driving circuit composed entirely of the oxide TFT also faces an important challenge, that is, the threshold voltage (Vth) of the oxide TFT is prone to drift. The drift of the threshold voltage will cause the output current of the driving transistor to be unstable, which in turn affects the uniformity of the display brightness, especially after long-term operation, this effect will be more obvious.

Therefore, how to design a TFT pixel driving circuit with a simple structure and good compensation effect to overcome the non-uniformity problem of display caused by the threshold voltage drift is a technical problem that needs to be solved by those skilled in the art.

In view of this, the present disclosure provides a pixel driving circuit and a display panel, aiming to provide a solution with a relatively simple structure, good compensation effect, and the ability to improve the display quality of the display panel.

The pixel driving circuit involved in the present disclosure is mainly used to drive the light-emitting device (such as OLED) to emit light. In order to ensure the display quality of the display panel, it is necessary to accurately control the current flowing through the light-emitting device. However, in a pixel circuit using a thin film transistor (TFT) as a driving element, the threshold voltage (Vth) of the TFT will drift due to process deviation, long-term operation and other factors, resulting in unstable driving current, thereby causing uneven display brightness. Therefore, how to effectively compensate for the threshold voltage drift of the TFT is the key to improving the display uniformity of the display panel. Flat panel display devices, especially OLEDs, are current-driven devices. This means that the luminance of the device is proportional to the magnitude of the current flowing through the device. Therefore, to achieve precise brightness control, the driving current needs to be precisely controlled. TFT is a voltage-controlled switching device. When the gate voltage exceeds the threshold voltage (Vth), the TFT is turned on and the current can flow between the source and the drain; conversely, the TFT is turned off and the current is almost zero. In the current-voltage characteristic curve of the TFT, the threshold voltage is an important parameter to distinguish the on and off states of the TFT. Due to the influence of various factors, the threshold voltage of the TFT will drift, that is, the value of Vth will change. For the driving TFT, the drift of Vth will cause the current flowing through the TFT to change under the same gate voltage, thereby affecting the brightness of the light-emitting device and causing uneven display. The present disclosure aims to solve the problem of display unevenness caused by the drift of the threshold voltage of the driving TFT in the pixel driving circuit composed of TFT, and further in the pixel driving circuit composed entirely of oxide TFT. Through a specific circuit structure and driving method, the present disclosure strives to achieve effective compensation for the threshold voltage of the driving TFT, thereby improving the display quality of the display panel.

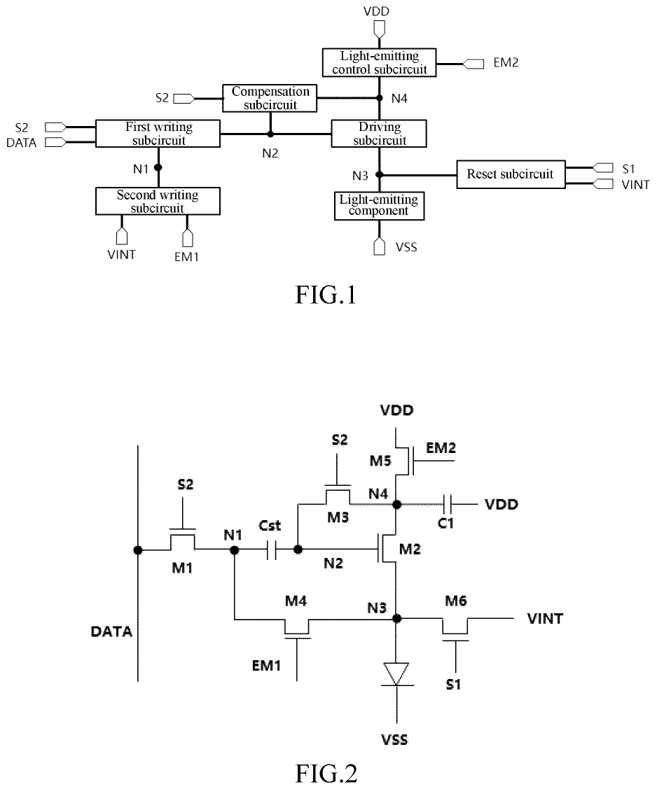

As shown in FIG. 1, one aspect of the embodiments of the present disclosure provides an internal compensation pixel driving circuit, which is composed of 6 functional modules, including: a light-emitting control subcircuit, a compensation subcircuit, a driving subcircuit, a reset subcircuit, a first writing subcircuit, a second writing subcircuit and a light-emitting component. The compensation subcircuit, the light-emitting control subcircuit and a first terminal of the driving subcircuit are connected to the fourth node N4, the compensation subcircuit, the first writing subcircuit and a gate of the driving subcircuit are connected to the second node N2, the reset subcircuit, the light-emitting component and a second terminal of the driving subcircuit are connected to the third node N3, and the second writing subcircuit and the first writing subcircuit are connected to the first node N1. The driving subcircuit provides a driving current for the light-emitting component, and the compensation subcircuit is used to eliminate the influence of the threshold voltage of the driving subcircuit on the light-emitting current provided by the light-emitting component. The light-emitting control subcircuit is used to control whether the driving current can be effectively transmitted to the light-emitting component, thereby controlling the light-emitting state of the light-emitting component (for example, turning on or off). In the embodiments of the present disclosure, the light-emitting control subcircuit is used to allow the driving current to flow to the light-emitting component in a specific time period, and prevent the driving current from flowing to the light-emitting component in other time periods, so as to achieve control of the light-emitting duration of the light-emitting component. For example, the light-emitting control subcircuit may include one switching transistor, and the path of the driving current is controlled by controlling the conduction and cutoff of the switching transistor. The type of the switching transistor may be an N-type or P-type thin film transistor, such as an oxide TFT or a LTPS TFT. In a non-limiting manner, the switching transistor may be an N-type oxide TFT. The compensation subcircuit is in generally used to compensate for the threshold voltage (Vth) drift of the driving transistor to improve the stability of the driving current. In the embodiments of the present disclosure, the compensation subcircuit is used to eliminate the influence of the threshold voltage of the driving subcircuit on the light-emitting current provided by the light-emitting component, thereby improving the uniformity of the display brightness. For example, the compensation subcircuit may include one storage capacitor for storing information related to the threshold voltage of the driving transistor. The driving subcircuit is used to control the current flowing through the light-emitting component according to the magnitude of the input signal, thereby controlling the light-emitting brightness. In the embodiments of the present disclosure, the driving subcircuit provides a driving current for the light-emitting component. The driving subcircuit may include one driving transistor, and the type of the driving transistor may be an N-type or P-type thin film transistor, such as an oxide TFT or a LTPS TFT. In a non-limiting manner, the driving transistor may be an N-type oxide TFT. The reset subcircuit is generally used to reset the voltage of the light-emitting device or related node(s) to a predetermined level before display of each frame begins, so as to eliminate the influence of the display of previous frame and prepare for the display of the next frame. In the embodiments of the present disclosure, the reset subcircuit is used to reset the anode (connected to the third node) of the light-emitting component to a reference voltage at a specific timing, thereby eliminating the influence of the residual charge of the previous frame. The reset subcircuit may include one switching transistor, and the reset function is realized by controlling the conduction and cutoff of the switching transistor. The type of the switching transistor may be an N-type or P-type thin film transistor, such as an oxide TFT or an LTPS TFT. In a non-limiting manner, the switching transistor may be an N-type oxide TFT. The writing subcircuit is generally used to write a data signal into the storage unit of the pixel circuit. In the embodiments of the present disclosure, the first writing subcircuit is used to write a data signal to a node connected to the gate of the driving subcircuit, such as the second node N2, at a specific timing, for example, it is stored through one storage capacitor. The first writing subcircuit may include one switching transistor, and the data writing function is realized by controlling the conduction and cutoff of the switching transistor. The type of the switch transistor may be an N-type or P-type thin film transistor, such as an oxide TFT or an LTPS TFT. In a non-limiting manner, the switch transistor may be an N-type oxide TFT. The second writing subcircuit is used to write a reference voltage to a node connected to the first writing subcircuit, such as the first node N1, at a specific timing, and affect the gate voltage of the driving transistor by capacitive coupling, thereby realizing threshold voltage compensation. The second writing subcircuit may include one switch transistor, and the writing function is realized by controlling the on and off of the switch transistor. The type of the switch transistor may be an N-type or P-type thin film transistor, such as an oxide TFT or an LTPS TFT. In a non-limiting manner, the switch transistor may be an N-type oxide TFT. The light-emitting component refers to a device capable of emitting light, such as an organic light-emitting diode (OLED), a micro light-emitting diode (Micro-LED), etc. In the embodiments of the present disclosure, the light-emitting component receives a driving current provided by the driving subcircuit and emits light. In a non-limiting manner, the light-emitting component may be an organic light-emitting diode (OLED). Connection in the embodiments of the present disclosure refers to an electrical connection, that is, two or more components or circuits are connected together through a conductive path so that current can flow between them.

Through the specific connection mode and timing control of the above subcircuits, effective compensation for the threshold voltage of the driving subcircuit can be achieved. The compensation subcircuit, the first writing subcircuit and the gate of the driving subcircuit are connected to the second node N2, which is a connection mode for achieving threshold voltage compensation. By storing information related to the threshold voltage in the compensation subcircuit under specific timing control, and adjusting the gate voltage of the driving subcircuit using such information during the driving stage, the influence of the threshold voltage drift is offset, so that the driving current is independent of the threshold voltage of the driving transistor.

In the driving control of the internal driving pixel driving circuit, it is usually necessary to configure related signal lines, such as a data terminal DATA, which is connected to the first writing subcircuit;
a first control terminal S1, which is connected to the gate of the reset subcircuit;
a second control terminal S2, which is connected to the gate of the first writing subcircuit and the gate of the compensation subcircuit;
a third control terminal EM1, which is connected to the gate of the second writing subcircuit;
a fourth control terminal EM2, which is connected to the gate of the light-emitting control subcircuit;
a reference voltage terminal VINT.

As shown in FIG. 2, the light-emitting component of the internal compensation pixel driving circuit specifically adopts an organic light-emitting diode, and the light-emitting component includes a first electrode and a second electrode. A driving voltage is applied between the first electrode of the light-emitting component and the second electrode of the light-emitting component to drive the light-emitting unit to emit light. Specifically, the first electrode of the light-emitting component is connected to the third node N3, and the second electrode is connected to the second power supply voltage line VSS. The light-emitting control subcircuit includes a fifth transistor M5, the first electrode of the fifth transistor M5 is connected to the first power supply voltage line VDD, the second electrode of the fifth transistor M5 is connected to the fourth node N4, and the gate of the fifth transistor M5 is connected to the fourth control terminal EM2. In an embodiment of the present disclosure, the light-emitting control subcircuit is used to control the path of the driving current from the driving subcircuit to the light-emitting component (OLED). Specifically, when the fourth control terminal EM2 is at an effective level, such as a high level, the fifth transistor M5 is turned on, and the driving current can flow from the first power supply voltage line VDD to the OLED through the fifth transistor M5 and the second transistor M2, driving the OLED to emit light; when the fourth control terminal EM2 is at an invalid level, such as a low level, the fifth transistor M5 is turned off, the driving current path is cut off, and the OLED does not emit light. By controlling the level of the fourth control terminal EM2, the light-emitting time of the OLED can be accurately controlled to realize the display function. In a non-limiting manner, the fifth transistor M5 can be an N-type oxide TFT.

The internal compensation pixel driving circuit further includes a reset circuit. The reset circuit includes a second storage unit C1, a first electrode of the second storage unit C1 is connected to the first power supply voltage line VDD, and a second electrode of the second storage unit C1 is connected to the fourth node. In an embodiment of the present disclosure, the second storage unit C1 is a capacitor that plays a role in storing charge in the circuit, thereby storing voltage information. Specifically, under a specific timing, the second storage unit C1 stores information related to the threshold voltage of the second transistor M2, that is, the potential of the first power supply voltage line VDD in the previous frame.

The compensation subcircuit includes a third transistor M3, a first electrode of the third transistor M3 is connected to the fourth node N4, a second electrode of the third transistor M3 is connected to the second node N2, and a gate of the third transistor M3 is connected to the second control terminal S2. In an embodiment of the present disclosure, the compensation subcircuit cooperates with the driving subcircuit and the first writing sub circuit to jointly realize compensation for the threshold voltage of the second transistor M2. Specifically, under a specific timing, by controlling the level of the second control terminal S2, the conduction and cutoff of the third transistor M3 can be controlled, thereby affecting the voltage of the second node N2, and combined with the function of the second storage unit C1, the potential of the first power supply voltage line VDD of the previous frame is stored in the second storage unit C1 for subsequent compensation operations. In a non-limiting manner, the third transistor M3 can be an N-type oxide TFT.

The driving subcircuit includes a second transistor M2, a first electrode of the second transistor M2 is connected to the fourth node N4, a second electrode of the second transistor M2 is connected to the third node N3, and a gate of the second transistor M2 is connected to the second node N2. In an embodiment of the present disclosure, the driving subcircuit is used to control the magnitude of the driving current flowing through the OLED according to the voltage of its gate, that is, the second node N2, so as to control the brightness of the OLED. The threshold voltage drift of the driving subcircuit is the main cause of display non-uniformity, so compensation is required. In a non-limiting manner, the second transistor M2 can be an N-type oxide TFT.

The reset subcircuit includes a sixth transistor M6, a first electrode of the sixth transistor M6 is connected to the reference voltage terminal VINT, a second electrode of the sixth transistor M6 is connected to the third node N3, and a gate of the sixth transistor M6 is connected to the first control terminal S1. In an embodiment of the present disclosure, the reset subcircuit is used to reset the anode of the OLED, that is, the third node N3, to the voltage of the reference voltage terminal VINT before display of each frame starts, so as to eliminate the residual charge in the display of the previous frame and prepare for the display of the next frame. Specifically, when the first control terminal S1 is at an effective level (e.g., a high level), the sixth transistor M6 is turned on, and the voltage of the reference voltage terminal VINT is applied to the N3 node to achieve reset; when the first control terminal S1 is at an invalid level (e.g., a low level), the sixth transistor M6 is turned off, and the third node N3 performs subsequent operations with other circuit(s). In a non-limiting manner, the sixth transistor M6 can be an N-type oxide TFT.

The first writing subcircuit includes a first transistor M1 and a first storage unit Cst, where a first electrode of the first transistor M1 is connected to the data terminal DATA, a second electrode of the first transistor M1 is connected to the first node N1, a gate of the first transistor M1 is connected to the second control terminal S2, a first electrode of the first storage unit Cst is connected to the first node N1, and a second electrode of the first storage unit Cst is connected to the second node N2. In the embodiment of the present disclosure, the first writing subcircuit is used to write the data signal of the data terminal DATA into the first storage unit Cst, and then couple to the gate of the second transistor M2, i.e., the second node N2, through the first storage unit Cst. Specifically, when the second control terminal S2 is at an effective level, such as a high level, the first transistor M1 is turned on, and the data signal of the data terminal DATA is written to the first node N1 through the first transistor M1. At the same time, since the first storage unit Cst is connected between the first node N1 and the second node N2, the data signal is coupled to the second node N2 through the first storage unit Cst, thereby affecting the gate voltage of the second transistor M2. When the second control terminal S2 becomes an invalid level, the first transistor M1 is turned off, and the first storage unit Cst maintains the voltage of the first node N1 until the next write operation. The first storage unit Cst is usually a capacitor. In a non-limiting manner, the first transistor M1 can be an N-type oxide TFT.

The second writing subcircuit includes a fourth transistor M4, a first electrode of the fourth transistor M4 is connected to the third node N3, a second electrode of the fourth transistor M4 is connected to the first node N1, a gate of the fourth transistor M4 is connected to the third control terminal EM1, the voltage of the reference voltage terminal VINT is connected to the first writing subcircuit through the second writing subcircuit, and the second writing subcircuit is connected to the gate of the driving subcircuit through the first storage unit Cst. In an embodiment of the present disclosure, the second writing subcircuit is used to transfer the reference voltage VINT to the first node N1 at a specific timing, and in combination with the coupling effect of the first storage unit Cst, the data information is indirectly transferred to the gate of the second transistor M2, that is, the second node N2, thereby realizing threshold voltage compensation. Specifically, when the third control terminal EM1 is at an effective level, such as a high level, the fourth transistor M4 is turned on. Since the reference voltage terminal VINT is connected to the third node N3 through the sixth transistor M6, the voltage of the third node N3 is the reference voltage VINT, and the voltage of the first node N1 is transferred to the third node N3, and coupled to the second node N2 through the first storage unit Cst, completing data writing and threshold voltage compensation. When the third control terminal EM1 is at an invalid level, such as a low level, the fourth transistor M4 is turned off. In a non-limiting manner, the fourth transistor M4 can be an N-type oxide TFT.

In some embodiments, the light-emitting control subcircuit, the compensation subcircuit, the driving subcircuit, the reset subcircuit, the first writing subcircuit, the second writing subcircuit and the thin film transistor (TFT) in the light-emitting component are all oxide TFTs (IGZO). Specifically, as shown in FIG. 2, the first transistor M1, the second transistor M2, the third transistor M3, the fourth transistor M4, the fifth transistor M5, and the sixth transistor M6 are all N-type oxide thin film transistors (TFTs) (IGZO). The oxide TFTs have relatively high electron mobility, which means that under the same gate voltage, the oxide TFTs can provide a relatively large driving current. This is particularly important for driving current-driven devices such as OLEDs, which can increase display brightness and reduce power consumption. The oxide TFTs have extremely low leakage current, especially in the off state. This is very beneficial for low refresh rate display applications, which can effectively reduce the power consumption of pixels during non-luminous periods and avoid problems such as display screen flickering caused by leakage current. The uniformity of the oxide TFTs is relatively good, which helps to improve the overall display quality of the display panel and reduce display unevenness caused by uneven TFT characteristics. Compared with LTPS TFTs, the process of the oxide TFTs is relatively simple, the cost is low, and it is easier to mass produce. In an embodiment of the present disclosure, the oxide TFTs are used as transistors in each subcircuit, which fully utilizes the above-mentioned advantages of the oxide TFTs to better solve the technical problem to be solved by the present disclosure, that is, to compensate for the threshold voltage drift of the driving transistor and improve display uniformity. Specifically, the driving subcircuit, i.e., the second transistor M2, uses the oxide TFT, which can provide sufficient driving current and reduce leakage current, thereby ensuring normal luminescence and low power consumption of the OLED. The compensation subcircuit, the light-emitting control subcircuit, the reset subcircuit, the first writing subcircuit and the second writing subcircuit adopt the oxide TFT, which can make full use of the low leakage current characteristics of the oxide TFT, reduce the power consumption of the circuit in the non-working state, and improve the stability of the circuit. In addition, the good uniformity of the oxide TFT also helps to improve the performance consistency of the overall circuit, reduce the difference between pixels, and further improve the display uniformity. In the embodiment of the present disclosure, by adopting the oxide TFT (IGZO) as the transistor of each subcircuit, it can not only effectively compensate for the threshold voltage drift of the driving transistor, thereby improving the brightness uniformity and display stability of the display panel, but also further reduce power consumption and improve the performance of the overall circuit. Although the N-type oxide thin film transistor TFT (IGZO) is preferably used in this embodiment, in other embodiments, other types of thin film transistors, such as P-type oxide TFT, amorphous silicon TFT or LTPS TFT, etc., can also be used according to actual needs, which does not deviate from the scope of protection of the present disclosure.

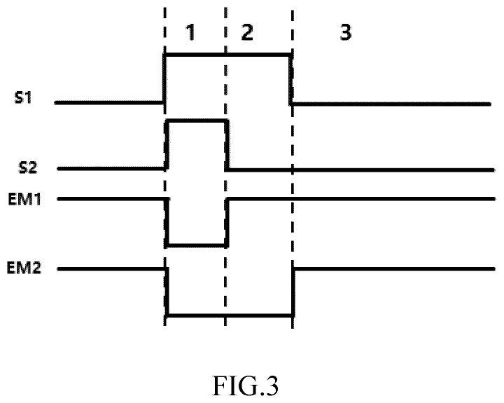

As shown in FIG. 3, a waveform diagram of an internal compensation pixel driving circuit in operation provided by an embodiment of the present disclosure is shown. Based on the same inventive concept, another aspect of the embodiment of the present disclosure also provides a driving method of an internal compensation pixel driving circuit, including the following stages.

In the first stage, a high-level signal is inputted to the first control terminal S1 and the second control terminal S2, a low-level signal is inputted to the third control terminal EM1 and the fourth control terminal EM2, the compensation subcircuit and the first writing subcircuit are in a conducting state, and a data signal of the data terminal DATA is transmitted to the first node. Specifically, in combination with FIGS. 2 and 3, when S1 and S2 are at a high potential, and EM1 and EM2 are at a low potential, the first transistor M1, the third transistor M3 and the sixth transistor M6 are turned on, while the fourth transistor M4 and the fifth transistor M5 are turned off. At this time, the voltage of the data terminal DATA is written to the first node N1 through the turned-on first transistor M1, so that the potential of the first node N1 is the voltage of the data terminal DATA. At the same time, since the sixth transistor M6 is also turned on, the reference voltage VINT is applied to the third node N3. In addition, since the second storage unit C1 stores the potential of the first power supply voltage line VDD of the previous frame, this potential turns on the second transistor M2. After the second transistor M2 is turned on, the potential of the reference voltage terminal VINT is written to the second node N2 through the second transistor M2 and the third transistor M3. Therefore, the potential of the second node N2 is finally pulled up to VINT+Vth, where Vth is the threshold voltage of the second transistor M2. At the end of this stage, the potential of the first node N1 is the potential of the data terminal DATA, and the potential of the second node N2 is VINT+Vth. This stage completes the preliminary writing of the data signal and the storage of the threshold voltage of the second transistor M2.

In the second stage, a high-level signal is inputted to the first control terminal and the third control terminal, a low-level signal is inputted to the second control terminal and the fourth control terminal, the second writing subcircuit and the reset subcircuit are in the conducting state, and the data signal is written to the second node. Specifically, in combination with FIG. 2 and FIG. 3, when the first control terminal S1 and the third control terminal EM1 are at a high potential, and the second control terminal S2 and the fourth control terminal EM2 are at a low potential, the fourth transistor M4 is turned on, while the first transistor M1 and the third transistor M3 are turned off. At this time, the potential of the first node N1 changes from the potential of the data terminal DATA to VINT. Since the second node N2 is in a floating state at this time, the voltage change of the first node N1 is coupled to the second node N2 through the first storage unit Cst, so that the potential of the second node N2 changes accordingly. Since the voltage change of the first node N1 is (VINT-DATA), the voltage change of the second node N2 is also approximately (VINT-DATA). Considering that the potential of the second node N2 in the first stage is VINT+Vth, at the end of the second stage, the final potential of the second node N2 is approximately VINT+Vth+(VINT−DATA), that is, 2VINT+Vth−DATA. In this stage, the data signal is written to the second node N2 through the coupling effect of the first storage unit Cst, and preparations are made for the subsequent threshold voltage compensation.

In the third stage, a high-level signal is inputted to the third control terminal and the fourth control terminal, a low-level signal is inputted to the first control terminal and the second control terminal, the second writing subcircuit and the light-emitting control circuit are in the on state, the working state of the driving subcircuit is controlled by the data signal, and the light-emitting component is driven to emit light. Specifically, in combination with FIGS. 2 and 3, when the third control terminal EM1 and the fourth control terminal EM2 are at a high potential, and the first control terminal S1 and the second control terminal S2 are at a low potential, the fourth transistor M4 and the fifth transistor M5 are turned on, and the first transistor M1, the third transistor M3 and the sixth transistor M6 are turned off. At this time, since the fourth transistor M4 is turned on, the first node N1 and the third node N3 are at the same potential, both VINT. The potential of the second node N2 has been determined to be 2VINT+Vth−DATA in the second stage. Therefore, the gate-source voltage Vgs of the second transistor M2 is the potential of the second node N2 minus the potential of the third node N3, that is, (2VINT+Vth−DATA)−VINT=VINT+Vth−DATA. At this time, the on state of the second transistor M2 is determined by the data signal. After the fifth transistor M5 is turned on, the driving current flows to the light-emitting component through the second transistor M2 and the fifth transistor M5, driving the light-emitting component to emit light. According to the current formula of the transistor, the light-emitting current Id can be expressed as:

$$\frac{1}{2} μ {C}_{ox} \frac{W}{L} {( {V}_{VINT} - {V}_{DATA} )}^{2}$$

where μ is the carrier mobility, Cₒₓ is the gate oxide capacitance,

$$\frac{W}{L}$$

is the width-to-length ratio, V_{VINT} is the reference voltage, and V_{DATA} is the voltage of the data signal DATA. It can be seen from the above formula that the light-emitting current Id is independent of the threshold voltage Vth of the second transistor M2, thereby effectively eliminating the influence of Vth drift on the light-emitting current and improving the display brightness uniformity.

Based on the same inventive concept, another aspect of the embodiment of the present disclosure also provides a display panel, including the above-mentioned internal compensation pixel driving circuit. The display panel can be applied to any product or component with display function such as a mobile phone, a tablet computer, a television, a display, a notebook computer, a digital photo frame, a navigator, etc. The specific implementation of the display panel can refer to the above-mentioned embodiments of the internal compensation pixel driving circuit, and the repetition of the technical solutions and technical effect will not be repeated.

The pixel driving circuit, display panel and driving method of the present disclosure, by adopting an internal compensation method, perform a separate threshold voltage compensation for each pixel, which can effectively eliminate the threshold voltage drift of the driving transistor caused by process deviation, long-term operation and the like, thereby ensuring the stability and consistency of the driving current and improving the uniformity of the display brightness. Since the threshold voltage drift is effectively compensated, the present disclosure can significantly improve the brightness uniformity of the display panel, avoid display defects such as uneven brightness and Mura, and enhance the viewing experience.

In summary, the internal compensation pixel driving circuit, driving method and display panel of the present disclosure adopt a specific circuit structure including a light-emitting control subcircuit, a compensation subcircuit, a driving subcircuit, a reset subcircuit, a first writing subcircuit and a second writing subcircuit, and connect these subcircuits together through a specific connection method. This specific circuit structure lays the foundation for realizing threshold voltage compensation. By applying precise timing signals to each control terminal, the conduction and cutoff of the transistors in each subcircuit are controlled, thereby realizing functions such as data writing, threshold voltage storage and compensation, and light emission control. The present disclosure adopts an internal compensation mechanism, that is, a compensation circuit is integrated inside the pixel circuit to compensate for the characteristics of each pixel separately. This method can more effectively eliminate the differences between pixels and improve display uniformity. Through the combination of the above circuit structure, timing control and internal compensation mechanism, the present disclosure can effectively eliminate the influence of the threshold voltage drift of the driving transistor on the light-emitting current, thereby improving the display uniformity of the display panel and enhancing the display stability.

In order to verify the effectiveness of the internal compensation pixel driving circuit and its driving method provided by the present disclosure, a circuit simulation was performed. In the simulation, the signal voltages are set as follows: the first power supply voltage line VDD=4.6V, the second power supply voltage line VSS=−2.8V, and the reference voltage terminal VINT=−2.5V.

OLED driving current under constant data voltage. In this embodiment, the voltage of the data terminal DATA is set to a constant value of −3V. Through simulation, the current flowing into the OLED device is measured to be approximately 54.7 nA. The results show that the circuit and driving method provided by the present disclosure can effectively drive the OLED device to emit light even at a relatively low data voltage.

OLED driving current under different data voltages. In this embodiment, individual signal voltages are set to VDD=4.6V, VSS=−2.8V, and VINT=−2.5V. The difference is that the voltage of the data terminal DATA changes in the range of −3V to 0V with a step of 0.1V. The simulation results show that the current flowing into the OLED device decreases as the DATA voltage increases. This change trend is consistent with the current-voltage characteristics of the OLED device, and also verifies that the circuit and driving method provided by the present disclosure can effectively control the brightness of the OLED.

It can be seen from the above two simulation results that the internal compensation pixel driving circuit and its driving method provided by the present disclosure can effectively drive the OLED device to emit light, and can accurately control the brightness of the OLED by adjusting the data voltage. This verifies that the present disclosure can effectively solve the display non-uniformity problem caused by the drift of the threshold voltage of the driving transistor in the related art.

The above content is a further detailed description of the present disclosure in combination with specific optional implementations, and it cannot be determined that the specific implementation of the present disclosure is limited to these descriptions. For ordinary technicians in the technical field to which the present disclosure belongs, several simple deductions or substitutions can be made without departing from the concept of the present disclosure, which should be regarded as belonging to the protection scope of the present disclosure.

What is claimed is:

1. An internal compensation pixel driving circuit, comprising: a light-emitting control subcircuit, a compensation subcircuit, a driving subcircuit, a reset subcircuit, a first writing subcircuit, a second writing subcircuit and a light-emitting component;
wherein the compensation subcircuit, the light-emitting control subcircuit and a first terminal of the driving subcircuit are connected to a fourth node, the compensation subcircuit, the first writing subcircuit and a gate of the driving subcircuit are connected to a second node, the reset subcircuit, the light-emitting component and a second terminal of the driving subcircuit are connected to a third node, and the second writing subcircuit and the first writing subcircuit are connected to a first node; and
the driving subcircuit provides a driving current for the light-emitting component, and the compensation subcircuit is used to eliminate an influence of a threshold voltage of the driving subcircuit on a light-emitting current provided by the light-emitting component.

2. The internal compensation pixel driving circuit according to claim 1, wherein the driving subcircuit is an oxide N-type thin film transistor.

3. The internal compensation pixel driving circuit according to claim 1, further comprising:
a data terminal connected to the first writing subcircuit;
a first control terminal connected to a gate of the reset subcircuit;
a second control terminal connected to a gate of the first writing subcircuit and a gate of the compensation subcircuit;
a third control terminal connected to a gate of the second writing subcircuit;
a fourth control terminal connected to a gate of the light-emitting control subcircuit.

4. The internal compensation pixel driving circuit according to claim 3, wherein the first writing subcircuit comprises a first storage unit, the data terminal is connected to the gate of the driving subcircuit through the first storage unit, and the first writing subcircuit writes data sent by the data terminal into the first storage unit under a control of the second control terminal.

5. The internal compensation pixel driving circuit according to claim 4, wherein the second writing subcircuit is connected to the gate of the driving subcircuit through the first storage unit.

6. The internal compensation pixel driving circuit according to claim 5, further comprising a reference voltage terminal, wherein the reference voltage terminal is connected to the third node through the reset subcircuit, and the reference voltage terminal is connected to the first writing subcircuit through the second writing subcircuit.

7. The internal compensation pixel driving circuit according to claim 1, further comprising a reset circuit, wherein the reset circuit is connected to the fourth node.

8. A display panel, comprising an internal compensation pixel driving circuit, comprising: a light-emitting control subcircuit, a compensation subcircuit, a driving subcircuit, a reset subcircuit, a first writing subcircuit, a second writing subcircuit and a light-emitting component;
wherein the compensation subcircuit, the light-emitting control subcircuit and a first terminal of the driving subcircuit are connected to a fourth node, the compensation subcircuit, the first writing subcircuit and a gate of the driving subcircuit are connected to a second node, the reset subcircuit, the light-emitting component and a second terminal of the driving subcircuit are connected to a third node, and the second writing subcircuit and the first writing subcircuit are connected to a first node; and
the driving subcircuit provides a driving current for the light-emitting component, and the compensation subcircuit is used to eliminate an influence of a threshold voltage of the driving subcircuit on a light-emitting current provided by the light-emitting component.

9. The display panel according to claim 8, wherein the driving subcircuit is an oxide N-type thin film transistor.

10. The display panel according to claim 8, wherein the internal compensation pixel driving circuit further comprises:
a data terminal connected to the first writing subcircuit;
a first control terminal connected to a gate of the reset subcircuit;
a second control terminal connected to a gate of the first writing subcircuit and a gate of the compensation subcircuit;
a third control terminal connected to a gate of the second writing subcircuit;
a fourth control terminal connected to a gate of the light-emitting control subcircuit.

11. The display panel according to claim 10, wherein the first writing subcircuit comprises a first storage unit, the data terminal is connected to the gate of the driving subcircuit through the first storage unit, and the first writing subcircuit writes data sent by the data terminal into the first storage unit under a control of the second control terminal.

12. The display panel according to claim 11, wherein the second writing subcircuit is connected to the gate of the driving subcircuit through the first storage unit.

13. The display panel according to claim 12, wherein the internal compensation pixel driving circuit further comprises a reference voltage terminal, wherein the reference voltage terminal is connected to the third node through the reset subcircuit, and the reference voltage terminal is connected to the first writing subcircuit through the second writing subcircuit.

14. The display panel according to claim 8, wherein the internal compensation pixel driving circuit further comprises a reset circuit, wherein the reset circuit is connected to the fourth node.

15. A driving method of an internal compensation pixel driving circuit, wherein the internal compensation pixel driving circuit comprises: a light-emitting control subcircuit, a compensation subcircuit, a driving subcircuit, a reset subcircuit, a first writing subcircuit, a second writing subcircuit and a light-emitting component;
wherein the compensation subcircuit, the light-emitting control subcircuit and a first terminal of the driving subcircuit are connected to a fourth node, the compensation subcircuit, the first writing subcircuit and a gate of the driving subcircuit are connected to a second node, the reset subcircuit, the light-emitting component and a second terminal of the driving subcircuit are connected to a third node, and the second writing subcircuit and the first writing subcircuit are connected to a first node; and
the driving subcircuit provides a driving current for the light-emitting component, and the compensation subcircuit is used to eliminate an influence of a threshold voltage of the driving subcircuit on a light-emitting current provided by the light-emitting component;
wherein the internal compensation pixel driving circuit further comprises:
a data terminal connected to the first writing subcircuit;
a first control terminal connected to a gate of the reset subcircuit;
a second control terminal connected to a gate of the first writing subcircuit and a gate of the compensation subcircuit;
a third control terminal connected to a gate of the second writing subcircuit;
a fourth control terminal connected to a gate of the light-emitting control subcircuit,
wherein the driving method comprises following stages:
in a first stage, inputting a high-level signal to the first control terminal and the second control terminal, inputting a low-level signal to the third control terminal and the fourth control terminal, the compensation subcircuit and the first writing subcircuit being in a conducting state, and transmitting a data signal of the data terminal to the first node;
in a second stage, inputting a high-level signal to the first control terminal and the third control terminal, inputting a low-level signal to the second control terminal and the fourth control terminal, the second writing subcircuit and the reset subcircuit being in a conducting state, and writing a data signal to the second node; and
in a third stage, inputting a high-level signal to the third control terminal and the fourth control terminal, inputting a low-level signal to the first control terminal and the second control terminal, the second writing subcircuit and the light-emitting control circuit being in a conducting state, controlling a working state of the driving subcircuit by a data signal, and driving the light-emitting component to emit light.

16. The driving method according to claim 15, wherein the internal compensation pixel driving circuit further comprises a reset circuit, and the reset circuit is connected to the fourth node;
in the first stage, a high potential of a previous frame stored in the reset circuit is written into the second node to turn on the driving subcircuit.

17. The driving method according to claim 15, wherein the driving subcircuit is an oxide N-type thin film transistor.

18. The driving method according to claim 15, wherein the first writing subcircuit comprises a first storage unit, the data terminal is connected to the gate of the driving subcircuit through the first storage unit, and the first writing subcircuit writes data sent by the data terminal into the first storage unit under a control of the second control terminal.

19. The driving method according to claim 18, wherein the second writing subcircuit is connected to the gate of the driving subcircuit through the first storage unit.

20. The driving method according to claim 19, wherein the internal compensation pixel driving circuit further comprises a reference voltage terminal, wherein the reference voltage terminal is connected to the third node through the reset subcircuit, and the reference voltage terminal is connected to the first writing subcircuit through the second writing subcircuit.
